(19) United States
(12) Patent Application Publication
(10) Pub. No.: US 2005/0086328 A1
(43) Pub. Date: Apr. 21, 2005

(54) Self configuring mobile device and system

(76) Inventors: Fredrick J. Landram, Pittsburgh, PA (US); Vincent P. Luciano, Port Jefferson, NY (US)

Correspondence Address: Cynthia S. Murphy;Renner, Otto, Boisselle & Sklar, LLP, Nineteenth Floor, 1621 Euclid Avenue, Cleveland, OH, 44115-2191, US

(21) Appl. No.: 10/688,316

(22) Filed: Oct. 17, 2003

(51) Int. Cl. G06F 15/177; G06F 15/16

(52) U.S. Cl. 709/220; 709/228

(57) ABSTRACT

A method of transacting business in conjunction with the sale of mobile devices is disclosed. The method includes shipping at least a first mobile device to a first end user and at least a second mobile device to a second end user different from the first end use. The first mobile device and the second mobile device generally have the same hardware and software configurations during shipping. At least one server, which is coupled to a network, is maintained with configuration data for a plurality of mobile devices. Upon receipt of the first mobile device and the second mobile device by the first end user and second end user, respectively, the first mobile device and the second mobile device are powered up. Upon being powered up, the first mobile device and the second mobile device each automatically connect to the at least one server via the network. The first mobile device downloads the first configuration data and second mobile device downloads the second configuration data from the at least one server, wherein the first configuration data and the second configuration data generally are different. Each respective mobile terminal automatically configures itself based on the first configuration data and the second configuration data.

### TECHNICAL FIELD

The present invention relates generally to mobile computer devices. More particularly, the present invention relates to a system and method in which mobile computer devices are automatically configured to an end user's requirements upon initial deployment of the mobile terminals.

### BACKGROUND OF THE INVENTION

In recent years, the use of wireless (e.g., cellular) communication systems having mobile devices which wirelessly communicate with a network, such as a local area network (LAN) and a wide area network (WAN), has become widespread. Retail stores and warehouses, for example, may use cellular communications systems to track inventory and replenish stock. The transportation industry may use such systems at large outdoor storage facilities to keep an accurate account of incoming and outgoing shipments. In manufacturing facilities, such systems are useful for tracking parts, completed products, defects, etc.

A typical cellular communication system includes a number of fixed routers interconnected by a cable medium often referred to as a system backbone. Also included in many cellular communication systems are intermediate routers which are not directly connected to the system backbone. Intermediate routers, often referred to as wireless routers, increase the area within which routers connected to the system backbone can communicate with mobile devices.

Associated with each wireless router is a geographic cell. A cell is a geographic area in which a wireless router has sufficient signal strength to transmit data to and receive data from a mobile device with an acceptable error rate. Typically, wireless routers will be positioned such that the combined cell area coverage from each wireless router provides full coverage of a building or site. Thus, mobile devices roaming within such an area can maintain continuous communication with a host computer or other device situated along the system backbone.

Each mobile device roaming within a building or site typically is preloaded with software to provide both application level and operational level instructional code (referred to generally herein as “operating software”). The mobile device includes one or more processors which execute the operating software, thereby allowing the mobile device to carry out its appropriate functions. The software is stored in memory in the mobile device and may be executed at any time depending on the particular operational needs of the mobile device. In addition to the operating software, each mobile device includes a configuration or “personality” stored in memory. As used herein, personality refers to the configuration settings of the mobile device that determine how the device will operate.

Mobile devices generally are designed and manufactured using standardized hardware platforms. Hardware may vary, for example, between different device models, but the hardware generally is consistent within a particular model. Therefore, each end user of a particular model of mobile device receives a unit whose hardware is substantially the same as units received by other end users. Unfortunately for the manufacturer of the mobile device, each end user does not operate its business in substantially the same manner as other end users. Therefore, the mobile devices must be tailored to the needs of each end user.

Presently, mobile devices are tailored to the needs of each end user through the use of different or customized application software and configuring the software to the specific needs of the end user. This requires that each device be loaded with the application software and subsequently configured before the mobile device can be used by the end user. Loading and configuring application software can involve a substantial effort and usually requires a service technician. Loading the software to the mobile device requires that a communication link (usually a serial link) be established between the mobile device and a host computer, such as a lap top computer, for example. Establishing a serial communications link is a two part step. First, a connection is made between the lap top computer and the mobile device, and second, the communications parameters, e.g., baud rate, parity, stop bits, etc. must be set in the mobile device and the lap top before they can communicate to each other. Once the communications link is established, the service technician proceeds to download the application software to each mobile device.

After the application software is downloaded to each mobile device, the mobile device must be configured to communicate on the end user's network. Additionally, each mobile device must be tailored to the end user's specific needs. This includes setting up device functionality, such as who may use the device, where it may be used, which applications may be accessed by a particular user, or any other requirement imposed by the end user. Depending on the number of mobile devices involved, one or more service technicians typically are required to assist in configuring the mobile devices for the particular end user.

Additionally, software updates periodically may be made available by the mobile device manufacturer, or the end user may choose to alter configuration settings of the mobile devices to suit a new need. The upgrade and/or reconfiguration of the mobile devices requires as much effort as described above with respect to a new “out of the box” device. Therefore, a service technician is required to perform the above described tasks for each mobile device in the end user's fleet. As the number of mobile devices operated by the end user increases, the task of maintaining the mobile devices requires a significant amount of manpower. Moreover, the current status, e.g., version of configuration settings, version of operating software, etc., of each mobile device must be managed so it is known which devices are up to date and which require upgrading. As a result of the present techniques used for commissioning and maintaining mobile devices, significant downtime and costs are incurred by the end user over the life of the mobile device.

In view of the aforementioned shortcomings associated with existing systems and techniques for commissioning and managing mobile devices, there is a strong need in the art for a system and method that does not require significant down time or service costs. Additionally, there is a strong need in the art for a system and method which avoids the inefficiencies associated with conventional wireless techniques for configuring mobile devices. Moreover, there is a strong need in the art for a mobile device that can be put in service by an end user shortly after it is removed from its box or other type packaging, with little or no intervention by technical personnel.

### SUMMARY OF THE INVENTION

In the light of the foregoing, the invention relates to a method of transacting business in conjunction with a sale of mobile devices. The method includes the steps: of shipping at least a first mobile device to a first end user and at least a second mobile device to a second end user different from the first end user, the first mobile device and the second mobile device having generally a same hardware and software configuration during shipping; maintaining on at least one server coupled to a network configuration data for a plurality of mobile devices; upon receipt of the first mobile device and the second mobile device by the first end user and second end user, respectively, powering up the first mobile device and the second mobile device; and upon being powered up, the first mobile device and the second mobile device each automatically connecting to the at least one server via the network; downloading first configuration data and second configuration data, respectively, from the at least one server, the first configuration data and the second configuration data being generally different; and automatically configuring themselves based on the first configuration data and the second configuration data.

A second aspect of the invention relates to a method for maintaining configuration data on a server coupled to a network. The method includes the steps of: storing in memory on the server different configuration data for a plurality of different mobile devices; the server receiving, via the network, requests for the different configuration data from the different mobile devices, respectively; and the server providing, via the network, the different configuration data to the different mobile devices, respectively.

A third aspect of the invention relates to a self configuring mobile device. The self configuring mobile device includes a discovery module for discovering device specific information on a wireless computer network; a communication module for transmitting data to and receiving data from the wireless computer network, wherein the communications module obtains device specific information from the discovery module to establish a communications link to at least one device; an update module operatively coupled to the communications module for querying the at least one device to obtain a configuration update; and a configuration module for configuring the mobile device, wherein the configuration module implements the configuration update to configure the mobile device to a custom configuration.

A fourth aspect of the invention relates to a wireless communication system, including at least one system backbone; at least one host computer coupled to the system backbone; a wireless remote station coupled to the at least one system backbone; and the self configuring mobile device, wherein the self configuring mobile device and the at least one host computer are operatively configured to wirelessly communicate configuration information therebetween, and the self configuring mobile device changes a first configuration setting to a second configuration based on a plurality of configuration data received from the at least one host computer, said second configuration setting being specific to a particular environment.

Other aspects, features, and advantages of the invention will become apparent from the following detailed description. It should be understood, however, that the detailed description and specific examples, while indicating several embodiments of the present invention, are given by way of illustration only and various modifications may naturally be performed without deviating from the present invention.

### BRIEF DESCRIPTION OF THE DRAWINGS

FIG. 1 is a block diagram of a wireless communication system in accordance with an exemplary embodiment of the present invention;

FIG. 2 is a hardware block diagram of a mobile terminal in accordance with the present invention;

FIG. 3 is a hardware block diagram of a computer server in accordance with the present invention;

FIG. 4 is a functional block diagram of the mobile terminal client in accordance with the present invention;

FIG. 5 is a functional block diagram of a computer server in accordance with the present invention;

FIG. 6 illustrates the contents of a database table stored in memory within the computer server, the database table including MAC addresses for each device, device profiles, operating systems and corresponding version numbers, and configuration data in accordance with the present invention;

FIG. 7 is a system flowchart suitable for programming a mobile device to communicate, request and download personality information from the computer server and configure the mobile device using the personality information in accordance with the present invention;

FIG. 8A is a system flowchart providing additional detail on the discovery step of the flow chart of FIG. 7;

FIG. 8B is a system flowchart providing additional detail on the manual configuration step of the flowchart of FIG. 7;

FIG. 9A is a system flowchart suitable for setting up the computer server to respond to the mobile device seeking configuration information in accordance with the present invention;

FIG. 9B is a system flowchart suitable for setting up the computer server to generate a scan sheet for secure manual configuration of a mobile terminal in accordance with the present invention; and

FIG. 9C is a system flow chart suitable for setting up the computer server to verify the scan sheet data entered into the mobile terminal in accordance with the present invention.

### DESCRIPTION

The present invention will now be described with reference to the drawings wherein like reference numerals are used to refer to like elements throughout.

As is mentioned above, the present invention relates to wireless (e.g., cellular) communication systems, which include mobile devices that can roam from cell to cell. Such mobile devices can be data terminals, telephones, pagers, etc. In the exemplary embodiment described hereinafter, each mobile device is a mobile data terminal (hereinafter “mobile terminal”) used to communicate data such as inventory or the like within a cellular system. However, it is recognized that the invention contemplates other types of mobile devices and is not intended to be limited to systems utilizing mobile terminals.

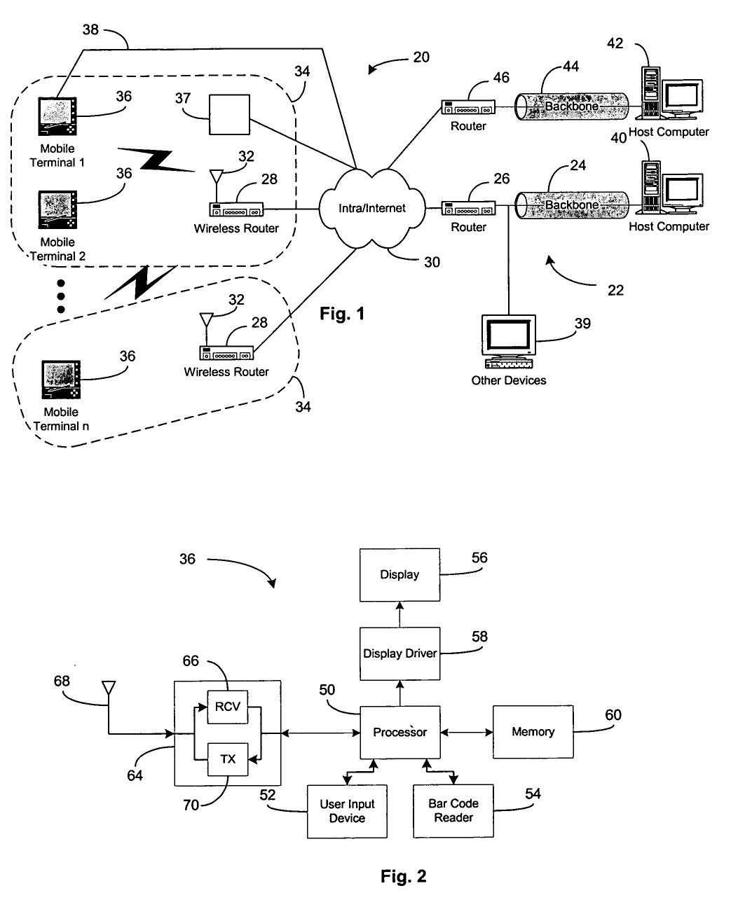

Referring now to FIG. 1, a cellular communication system 20 is shown in accordance with the exemplary embodiment of the present invention. The cellular communication system 20 includes a network 22 having a system backbone 24. The system backbone 24 may be a hardwired data communication path made of twisted pair cable, shielded coaxial cable or fiber optic cable, for example, or may be wireless in nature. Connected to the system backbone 24 is a first router 26. Several wireless routers 28, which can be located remotely or locally relative to the first router 26, are connected to the first router 26 through an internet and/or intranet connection 30. The connection of the first router 26 to the wireless routers 28 via the internet/intranet 30 provides a mechanism through which a communications link can be established to the backbone 24 anywhere internet access is available.

Each wireless router 28 is capable of wirelessly communicating with other devices in the system 20 via an antenna 32. A geographic cell 34 associated with each wireless router 28 defines a region of coverage in which successful wireless communication may occur. Depending on the type of antenna 32 selected and the output power of the respective router, the cell 34 may take one of several different forms and sizes. For example, FIG. 1 depicts the wireless router 28 utilizing an omni-directional antenna wherein a generally spherical cell area of coverage is obtained. However, a directed yagi-type antenna or other form of antenna could also be used as will be readily appreciated.

The cellular communication system 20 also includes one or more mobile terminals 36. Each mobile terminal 36 communicates with devices on the system backbone 24 via a selected wireless router 28 and/or with other mobile terminals 36. Upon roaming from one cell 34 to another, the mobile terminal 36 is configured to associate itself with a new wireless router 28 according to conventional techniques. In addition to wireless communications, each mobile terminal 36 also may communicate through a cradle 37. As is known in the art, a cradle is a device wherein a mobile terminal is stored when not in use. In addition to providing a storage function, cradles provide other functions, including a power connection for charging batteries and a communications link for transferring data. In another embodiment, the mobile terminal 36 may communicate through a wired connection 38.

Furthermore, the cellular communication system 20 may include one or more other devices 39 connected to the system backbone 24. Such devices 39 may include work terminals, printers, cash registers, etc.

In the exemplary embodiment, a server computer 40 (also referred to as a server or host computer 40) is responsible for supporting the network activities of the mobile terminals 36 within the system 20. As part of such function, the server 40 is responsible for maintaining device identification codes, device personalities, current versions of operating software, diagnostics and registration information for each of the mobile terminals 36. As used herein, device personality refers to the configuration or profile of a given mobile terminal. As will be described more fully below, the personality determines, for example, the applications loaded on the mobile terminal, the application configuration, the access granted to the operating system, and the functionality of the mobile terminal 36. The personality can be based on various criteria, such as the location of the device, a particular device user, or the device type itself.

It is noted that the server 40 can be a remote server operated by a third party, such as the manufacturer of the mobile terminals, for the exclusive purpose of providing a service to purchasers of its mobile terminals, e.g., an automatic configuration service. Alternatively, the server 40 can be operated by the end user of the mobile terminals 36. In this case, the end user is responsible for managing the contents of the server 40 to provide updates of its fleet of mobile terminals.

A second server 42 also can be connected to the internet/intranet 30 via a second backbone 44 and a second router 46. The second server 42 is responsible for managing the end user's data, such as inventory or parts tracking, for example. After the mobile terminals are automatically configured via the first server 40 and placed in service, they primarily communicate with the second server 42 to receive and transmit information relating to the particular business of the end user. The functions of the first server 40 and the second server 42 can be combined on a single server, if desired.

Traditionally, when a mobile terminal is put into service for the first time, a service technician is required to configure the terminal to communicate on a network, set up who may use the terminal, and various other restrictions and/or capabilities that may be implemented on the mobile terminal. As will be described more fully below, the mobile terminal 36 disclosed in the present invention can be completely automated to configure itself to the end user's system, without the need of a technician.

For example, an end user may purchase one hundred mobile terminals 36 from a mobile terminal manufacturer, who implements in the mobile terminals the techniques disclosed herein. The terminals 36 arrive at the at end user's facility and are delivered to the proper personnel. At this point, the mobile terminals are still in a generic state. That is, no configuration settings have been altered from the factory default settings.

An employee of the end user, who may or may not have technical training, simply removes each mobile terminal 36 from its packaging and turns it on (via an on/off switch). From this point forward, the mobile terminal takes control and undergoes a configuration and setup procedure. A few moments later the mobile terminal is configured for the end user's particular system and ready for use. The entire process effectively is transparent to the employee who just turned on the terminal. Moreover, costs to the end user are significantly reduced since the expenditure of time and the required expertise in setting up each mobile terminal 36 is averted. Additionally, the fleet of mobile terminals can be put into service almost immediately, thus permitting the end user to take advantage of the new technology implemented within the mobile terminals 36.

When a mobile terminal 36 within the system 20 initially is powered up, the mobile terminal 36 goes through an initialization, or boot-up routine. Such routine includes detecting the presence of a computer network (e.g., network 22) and discovery of its environment, network, services and associated peripherals. Environmental discovery can occur via wireless or a cradle connection. The mobile terminal 36 uses the discovered information to configure itself to communicate over the network 22 without administrative intervention. This includes finding an available network IP address, setting its address to the available IP address, and exchanging information with other devices on the network.

Once the mobile terminal 36 has established a network connection, it communicates with the server 40 via a selected wireless router 28. As will be discussed more fully below, the mobile terminal 36 identifies itself to the server 40 with a device specific identification code, which is issued during manufacture of the terminal 36. The server 40, using the identification code, accesses a database to retrieve device specific information relating to the mobile terminal 36. The information includes the particular personality information relating to the mobile terminal 36.

A determination is made during such boot-up routine whereby the mobile terminal 36 determines whether a personality update is required. If the mobile terminal determines a personality update is required, then the mobile terminal 36 issues a request to the server 40 to transmit to the mobile terminal 36 the upgraded version of the personality. If the mobile terminal 36 determines that a personality update is not required, then the mobile terminal 36 does not prompt the server 40 to transmit the personality and thus needless downloading of files is avoided.

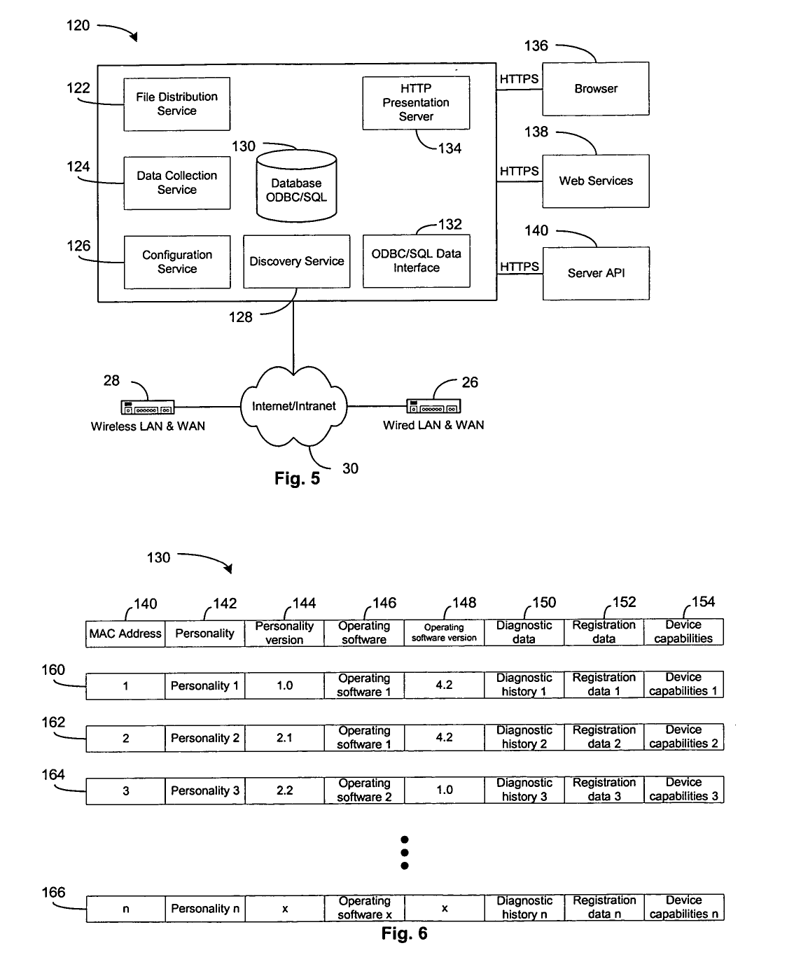

The device personality is used to configure the mobile terminal and, since the mobile terminal 36 is shipped in a generic state, generally is requested by the mobile terminal 36 only after its initial power up, e.g., the first power up after being removed from its shipping container. It should be appreciated, however, that the mobile terminal 36 can be configured to request a personality update from the server 40 on each power up or on specific intervals, such as once per month, for example. The device personality determines which software components are installed on the mobile terminal, which components are enabled/disabled, the functionality of the mobile terminal, who may have access to the terminal, etc. As will be described in more detail with reference to FIG. 6, information regarding the device personality is stored in a database located on the server 40.

Personalities may be dependant on the user, the location, the device or any other criteria as may be necessary. For example, a user dependant personality enables/disables access to specific applications and/or information based on who is currently logged into the mobile terminal. A manager may have access to account information, wholesale and retail prices, order entry and stock on hand, while a clerk only may have access to retail prices and stock on hand. User identification can be established by conventional techniques, such as requiring the user to log into the mobile terminal or by scanning an identification card, for example.

As will be appreciated, similar restrictions and/or capabilities can be placed on the device based on its location, e.g., a warehouse, a retail shop, a department within a store, or on the device itself, e.g., an “economy” or lightly equipped mobile terminal or a premium terminal having all options enabled.

After the personality is checked and, if necessary, upgraded to the latest version, the mobile terminal 36 determines whether an operating software update is available. Operating software updates can be performed in the same manner discussed above relating to personality updates. For example, the mobile terminal communicates with the server 40 and determines whether an operating software update is available. If an update of the operating software is available, the mobile terminal 36 issues a request to the server 40 to transmit to the mobile terminal 36 the upgraded operating software. Conversely, if an update is not available, then the mobile terminal 36 does not prompt the server 40 to retransmit the operating software.

Once the personality has been configured and the latest operating software has been installed, the mobile terminal is ready for use. Alternatively, additional features, such as, for example, network diagnostics and automatic terminal registration can be performed prior to placing the terminal into service. Upon completion of the above described procedures, the mobile terminal 36 is configured for the end user's specific system and the employee, who a few moments earlier removed the terminal from its box, can use the mobile terminal in his job duties.

Accordingly, provisioning of mobile terminals to an end user's requirements can be accomplished with little to no administrative intervention. Morever, an entire fleet of mobile terminals can be deployed by non-technical personnel. A mobile terminal simply is removed from its shipping container, powered on and it is automatically configured to the end user's requirements. The terminal can be used immediately, without waiting for a service technician to load and configure each terminal. Thus, provisioning costs to the end user are minimized.

Furthermore, the mobile terminal's configuration and operating software easily can be changed and/or upgraded by managing the database on the server 40. This further reduces the overall cost of ownership of the mobile terminal and enhances the end user's experience with the product. Manual updates of each device effectively will be eliminated. Additionally, the automatic updates ensure that each terminal is operating with the latest software and/or configuration, thus minimizing security risks and troubleshooting costs as well as increasing uptime and productivity. As will be described in more detail below, the overall end user's experience is further enhanced through the use other automated features, such as automatic device registration and built in diagnostic testing/logging, for example.

FIG. 2 is a block diagram representing the basic structure of each of the mobile terminals according to the exemplary embodiment. Each mobile terminal 36 includes a processor 50 which can be programmed to control and to operate the various components within the mobile terminal 36 in order to carry out the various functions described herein. The processor 50 may be, for example, an AMD Athlon™ or similar type microprocessor. The processor 50 is coupled to a user input device 52 which allows a user to input data to be communicated to the system backbone 24 such as inventory data, patient information, etc. This information may be sent to the second server 42 which serves as a central data location, for example, or to a cash register connected to the system backbone 24, as another example, for providing price information. Furthermore, the input device 52 allows a user to input a software availability request as is discussed in more detail below. The input device 52 can include such items as a keypad, touch sensitive display, etc. The mobile terminal 36 also may include a bar code reader 54 coupled to the processor 50 for providing another form of data input. A display 56 also is connected to and controlled by the processor 50 via a display driver circuit 58. The display 56 serves as a means for displaying information stored within the mobile terminal 36 and/or received over the system backbone 24 via the wireless router 28. The display 56 can be a flat panel liquid crystal display with alphanumeric capabilities, for example, or any other type of display as will be appreciated.

Each mobile terminal 36 also includes a memory 60 for storing program code executed by the processor 50 for carrying out the functions described herein. In particular, the memory 60 includes a non-volatile portion (e.g., an EEPROM) for storing mobile terminal operating software which is executed by the processor 50 in order to carry out the desired operations of the mobile terminal 36. The particular operating software is not critical to the invention and it will suffice to say that such operating software typically will be related to the application of the mobile terminal, e.g., communication protocols, utility programs such as for inventory control, patient care, etc. As noted above, however, it may be desirable at times to upgrade such operating software and/or device personality with revised and/or completely different software. Thus, the memory 60 also has stored therein code which is executed by the processor 50 in order to perform the functions for downloading upgraded operating software and/or device personality from the server 40. The actual code for performing such functions can be easily programmed by a person having ordinary skill in the art of computer programming in any of a number of conventional programming languages based on the disclosure herein. Consequently, further detail as to the particular code itself has been omitted for sake of brevity.

The processor 50 also stores in the memory 60 information relating to the version of mobile terminal personality and/or operating software. The processor 50 compares this information with information received from the server 40 to determine whether a new personality and/or operating software is available. If the processor determines a new personality and/or operating software is available, the processor 50 proceeds to request that the server 40 download the new personality and/or operating software and the processor 50 goes on to replace the previous personality and/or operating software which was stored in the memory 60 with the upgraded operating version from the system 40.

Each mobile terminal 36 also includes its own RF transceiver section 64 connected to the processor 50. The RF transceiver section 64 includes an RF receiver 66 which receives RF transmissions from the wireless router 28 via an antenna 68 and demodulates the signal to obtain the digital information modulated therein.

The RF transceiver section 64 also includes an RF transmitter 70. In the event the mobile terminal 36 is to transmit information to the backbone 24 in response to an operator input at input device 52 or as part of its boot-up routine, for example, the processor 50 forms digital information packets which are then delivered to the RF transmitter 70. According to conventional techniques, the RF transmitter 70 transmits an RF signal with the information packets modulated thereon via the antenna 68 to the wireless router 28 with which the mobile terminal 36 is registered.

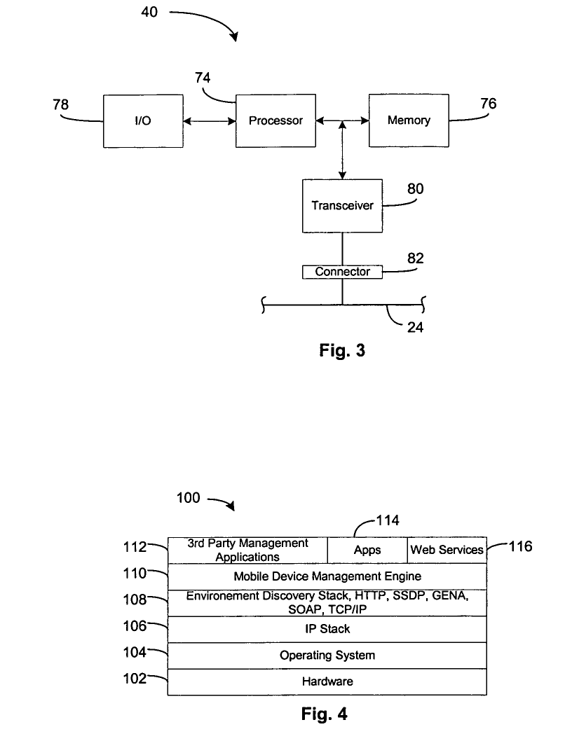

Referring now to FIG. 3, a block diagram of the server 40 is provided. The server 40 may be a personal computer, for example, and includes its own processor 74 (e.g., an AMD Athlon™ XP or Intel Pentium IV® processor). Coupled to the processor 74 is a memory 76 for storing code for controlling the operation of the server 40 in accordance with the description provided herein. Again, based on the description provided herein, a person having ordinary skill in the art of computer networks and system administration will be able to set up the server 40 to support the various operations described herein. Accordingly, additional detail is omitted.

The memory 76 may include, but certainly is not limited to, a hard disk storage medium. The memory 76 also has stored therein the aforementioned current versions of the mobile terminal device personality and/or operating software for the various mobile terminals 36 included in the system 20. As will be described in more detail with reference to FIG. 6, there is stored in the memory 76 a database table. Briefly, the database table is maintained by the processor 74 and is arranged to include an entry for each mobile terminal within the system 20. Each entry includes the identification code of the mobile terminal, such as a Media Access Control (MAC) address, for example. Other identification entries include a device serial number, a CPU identification, or a combination of several identifiers.

The processor 74 is coupled to an input/output (I/O) port or device 78 as shown in FIG. 3. The I/O device 78 may include a floppy disk drive or the like which enables a system operator to transfer upgraded mobile terminal operating software into the memory 76 using conventional file transfer techniques. The processor 74 is coupled to the system backbone 24 by way of a network adaptor transceiver 80 and connector 82 as is conventional. The server 40 is able to transmit and receive information over the system backbone 24 via the transceiver 80 and connector 82.

Moving to FIG. 4, a block diagram illustrating the interrelation of various hardware and software modules within the mobile terminal 36 is shown. Included in the mobile terminal 36 is the hardware 102, e.g., the processor 50, the memory 60, etc., the operating system 104, e.g., Windows CE or PocketPC, and the IP stack 106, as is conventional. Additionally, an environment discovery stack 108 is included in the mobile terminal 36. The environment discovery stack includes several well-tested protocols, such as Simple Service Description Protocol (SSDP), Simple Object Access Protocol (SOAP), and General Event Notification Architecture (GENA), HTTP and TCP/IP.

As is known in the art, an environment discovery stack is an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. The environment discovery stack is a distributed, open networking architecture that leverages TCP/IP and Web technologies to enable seamless proximity networking in addition to control and data transfer among networked devices in the home, office, and public spaces.

The environment discovery stack is designed to support zero-configuration, “invisible” networking, and automatic discovery for a breadth of device categories from a wide range of vendors. A device can dynamically join a network, obtain an IP address, convey its capabilities, and learn about the presence and capabilities of other devices. DHCP and DNS servers are optional and are used only if available on the network. Finally, a device can leave a network smoothly and automatically without leaving any unwanted state behind.

Also included in the mobile terminal 36 is a Mobile Device Management Engine or client 110. The client 110 is a device resident software module that interacts with a server component (described below) to manage and monitor the update and operation of both third party applications 112 and proprietary applications 114 on the mobile terminal 36. Third party applications 112 include, for example, a database program, a spread sheet program, inventory management applications and remote control software applications. Proprietary applications 114 include applications for manually configuring the mobile terminal 36, such as an “on device wizard” with optional scannable inputs and/or a cloning interface to duplicate the personality of one device into multiple devices.

Additionally, the client 110 collects device performance data to manage the health of the mobile terminal 36. The core functionality of the client includes network connection/security/device diagnostics, environment discovery, peripheral device discovery proxy, version checking and update, statistic collection and link test, remote command processing, device lock-down and event generation, for example.

A Web services module 116 integrates Web-based applications using, for example, SOAP, Extensible Markup Language (XML), Web Services Description Language (WSDL) and Universal Description, Discovery and Integration (UDDI) open standards over an Internet protocol backbone as is conventional. XML is used to tag data, SOAP is used to transfer the data, WSDL is used for describing the services available and UDDI is used for listing what services are available. The Web services module 116 allows different applications from different sources to communicate with each other without time-consuming custom coding. Additionally, the Web services module 116 is not tied to any one operating system or programming language.

Moving to FIG. 5, a server block diagram 120 illustrating the modules residing on the server 40 is shown. The server 40 is the control, data collection and distribution point for managing mobile computing devices, such as the mobile terminal 36, for example. The server 40 provides the services required to gather and store accurate and abundant data through automated data collection performed by the client 110 of the mobile terminal 36. The server 40 utilizes, for example, a standard ODBC/SQL database to process data for management and reporting using standard database interfacing tools. This allows for intensive data analysis to be performed by back-end server applications as well as allowing data aggregation with 3^{rd} party management tools. The functions of each service are briefly discussed below.

The server 40 includes several conventional services, including a file distribution service 122 and a data collection service 124. The file distribution service 122 coordinates file transfers between the server 40 and the mobile terminal 36. For example, when a request is made by the mobile terminal 36 for an operating software update, the file distribution service 122 coordinates the transfer of the appropriate files from the server 40 to the mobile terminal 36. Similarly, when the mobile terminal 36 transfers files to the server 40, the file distribution service 122 coordinates the reception of the files and the corresponding placement of the files in the server memory 76, for example.

The data collection service 124 coordinates the accumulation of data from each mobile terminal 36. For example, as the mobile terminal 36 collects diagnostic data and/or detects the occurrence of an event, the data and/or event is transmitted to the server 40 for recording. The data collection service organizes the data into coordinated files for easy management, retrieval and/or viewing at a later time.

The server 40 also includes a configuration service 126 and a discovery service 128. The configuration service 126 interacts with each mobile terminal 36 to configure the mobile terminal to have a specific device personality. More particularly, the configuration service 126 receives personality information (e.g. the operational mode of the terminal) from a database 130 and organizes the information into a downloadable file that is meaningful to the processor 50. The file then is transferred to the mobile terminal 36 via the file distribution service 122, for example, and the mobile terminal 36 uses the new configuration settings to overwrite its old configuration settings.

The discovery service 128 operates in conjunction with the environment discovery stack 108 of the mobile terminal 36. The discovery service 128 provides support for zero-configuration, invisible networking and automatic discovery of devices on the network 22. The discovery service 128 monitors the arrival and departure of devices, e.g., mobile terminals 36, on the network 22 and stores information regarding the services and embedded functions of each device along with any associated peripheral devices.

In addition to the above described services, several conventional support modules also reside on the server 40. These modules include an ODBC/SQL data interface 132 and an HTTP presentation server 134.

The ODBC/SQL Data Interface 132 provides a means to access the data in the database 130. For example, the data interface 132 is a user interface that facilitates the entry, manipulation and/or extraction of data from the data base 130. ODBC/SQL data interfaces are well known by those having ordinary skill in computer programming and will not be discussed in detail herein.

The HTTP presentation server 134 determines the actions a browser 136 and Web server (not shown) take in response to various commands as is conventional. For example, when a URL is entered into a browser 136, an HTTP command is sent to the Web server directing it to fetch and transmit the requested Web page. Web services 138, which are located on the Web server, execute the commands from the HTTP presentation server 134. Alternatively, an Application Program Interface (API) server 140 can be used in place of the Web services 138. Using this framework, functions and data of the client 110 can be made available to in-terminal applications and/or remote servers.

Moving to FIG. 6, a block diagram representing the organization of data in the database 130 is illustrated. The database 130 includes several entries for identifying and configuring each mobile terminal 36.

The database 130 has a identification entry 140 for identifying each particular mobile terminal 36. In the exemplary embodiment the mobile terminal 36 is identified through a MAC address, although it should be appreciated that other forms of identification may be employed without departing from the scope of the present invention. As is known in the art, a MAC address is a hardware address that uniquely identifies each node of a network. Generally, the MAC address is a hexadecimal number that is assigned to the device during manufacture, wherein each device is assigned a different number. Information for a particular mobile terminal 36 is stored in and retrieved from the database 130 using the MAC address as the criteria for all information related to the particular mobile terminal 36.

The database 130 also includes a personality entry 142, which identifies the particular personality configuration of the mobile terminal 36. The personality entry 142 is used by the mobile terminal 36 to automatically configure itself. As described previously, the mobile terminal can be configured in one of several modes, such as, for example, a location profile, a user profile and a device profile.

A location personality enables/disables access to specific applications and/or information based on the location of intended use for the device. A mobile terminal 36 intended for use strictly in a warehouse environment may require access to stock on hand and wholesale prices, for example. A mobile terminal 36 intended for use in a retail environment, on the other hand, may require access to the retail price of an item, the quantity on hand, delivery dates of stock, etc.

A user dependant personality enables/disables access to specific applications and/or information based on who is currently logged into the mobile terminal 36. For example, a manager may have access to a wide range of information relating to an item and/or an account, while a clerk only may have access to a limited amount of information.

A device personality enables/disables access to specific applications and/or information based on the model number of the device, for example. A base or “economy” model only may have access to a limited amount of information. Additionally, certain applications may not be available for execution by the mobile terminal. A top of the line or premium device may have access to all information and/or to all applications provided by the manufacturer, for example.

The particular format of the personality configuration stored in the personality entry 146 of the database 130 is not related to the invention and any one of several formats can be implemented. For example, the personality configuration can be stored as a hexadecimal number, wherein each bit within the hexadecimal number corresponds to a particular configuration setting. Personality configurations having a value of 1h can correspond to a basic user profile, 2h can correspond to a basic location profile, and so on. It is noted that while the present invention has been discussed using a user, location and device profile, numerous other configuration schemes are possible and these profiles are not intended to be limiting in any way.

Since hexadecimal numbers can be difficult for non-technical person to comprehend, a graphical user interface (GUI) can be used to assist in configuring the device personality. Using conventional techniques, an interface can be designed that is intuitive to the user. Once the user has configured the personality of the mobile terminal 36 through the GUI, the GUI outputs a personality configuration corresponding to the above described criteria, for example, and the configuration is stored on the server 40.

Alternatively, the personality configuration can be stored as a file on the server 40, and the personality entry 142 points to the location of the file on the server 40. As was described above for the hexadecimal storage format, a GUI front end can be implemented to assist a user in configuring the mobile terminal personality. Once all parameters are defined, the GUI can generate a file that is meaningful to the mobile terminal 36, for example. The file then is stored on the server 40 for later retrieval during personality updates, and the file location is entered in the personality entry 142.

A corresponding personality version entry 144 indicates the particular version of the personalty data. As is conventional, each personality configuration is identified by a particular version indicator. By comparing the version of personality in its memory with the version stored on the server 40, the mobile terminal 36 quickly can identify whether a new personality is available.

The database 130 also includes an operating software entry 146, which uniquely identifies the particular operating software employed in the mobile terminal 36. All updates for a particular operating software are stored on the server 40 in a unique directory from other versions and/or types of operating software. The operating software used by the mobile device 36 can depend on various factors, including the make and model of the mobile terminal and/or specific applications required by the device personality, for example. As stated above, operating software refers to software that provides both application level and operational level instructional code. Operational level code includes operating systems, such as Windows CE and PocketPC, for example. The actual operating software used in each mobile terminal 36 is not germane to the invention.

Along with the software platform entry 146, a corresponding software version entry 148 identifies the particular version of the operating software installed on the mobile terminal 36. As is known in the art, new software versions are introduced as upgrades and/or bug fixes for a particular piece of software are released. These software upgrades are tracked based on a version number entered in the database. By comparing the version number of the software on the mobile terminal 36 with the version number of the software in the software version entry 148, a quick determination can be made as to whether or not the operating software is out of date.

A diagnostic data entry 150 is used to store diagnostic data received from the mobile terminal 36. During power up of the mobile terminal 36 and subsequent operation, the mobile terminal collects diagnostic data for future use in the event it experiences technical difficulties. The diagnostic data is stored in the mobile terminal memory 60 and/or in the database 130 stored on the server 40. The diagnostic data can be retrieved at a later time from the database 130 and used to assist in troubleshooting a mobile terminal 36. The diagnostic data can be stored on the server 40 in a file format, for example, and the diagnostic entry 150 points to the location of the file on the server 40. As will be appreciated by those skilled in the art of computer programming, numerous other methods of diagnostic storage and retrieval can be implemented and the illustrated example is not intended to be limiting in any way.

A registration entry 152 stores registration data related to each mobile terminal 36. Registration data includes various information on the mobile terminal 36, including, for example, model number, date placed in service and product owner (if entered). Product registration provides a means of contacting the product owner should updates be available for the product. Unfortunately, many individuals fail to register their products with the manufacturer, mainly due to the hassle of preparing the registration information and mailing the information to the manufacturer. The automatic registration feature reduces the effort required by the product owner and thus increases the likelihood of product registration.

A device capabilities entry 154 stores the capabilities of each mobile terminal 36. As stated previously, when a mobile terminal accesses a network, it announces its presence on the network and its capabilities. The server 40 receives this information and stores the capabilities of the device in the device capabilities entry 154. This information is used by the server 40 for managing the network and for efficient utilization of its network resources, for example.

The database 130 can be organized in a row-column format, wherein each column represents a specific piece of information and each row represents a particular mobile terminal 36. For example, a first row 160 includes all data pertaining to a mobile terminal having a MAC address of 1. All data related to the particular mobile terminal 36 can be found in the first row, e.g., personality, personality version, software platform, software version, etc. A second row 162 includes all data pertaining to a mobile terminal 36 having a MAC address of 2, and a third row 164 includes all data pertaining to a mobile terminal 36 having a MAC address of 3. As will be appreciated, this process can be repeated to include all mobile terminals manufactured, as shown in the last row 166, wherein “n” corresponds to the last MAC address issued. Alternatively, the database can include all mobile terminals owned by a specific entity, for example. Such would be the case when a user prefers to manage his own fleet of mobile terminals, as opposed to an outside entity performing the management of the mobile terminals. It also should be appreciated that although the database 130 is shown in a row-column format wherein the row signifies a particular mobile terminal and the column signifies a specific entry type, other forms of the database can be constructed without departing from the scope of the invention. For example, the database can be constructed where the column signifies a particular mobile terminal and the row signifies a specific entry type.

It will be appreciated by those skilled in the art that although the above described database is illustrated using a single column for each particular entry, multiple columns may be employed where required. For example, the registration entry 152, which is shown as a single entry for each terminal 36, can be expanded into multiple entries, including one for the product model number, one for the date placed in service, one for the product owner, etc. This same principle can be applied to the remaining entries as required.

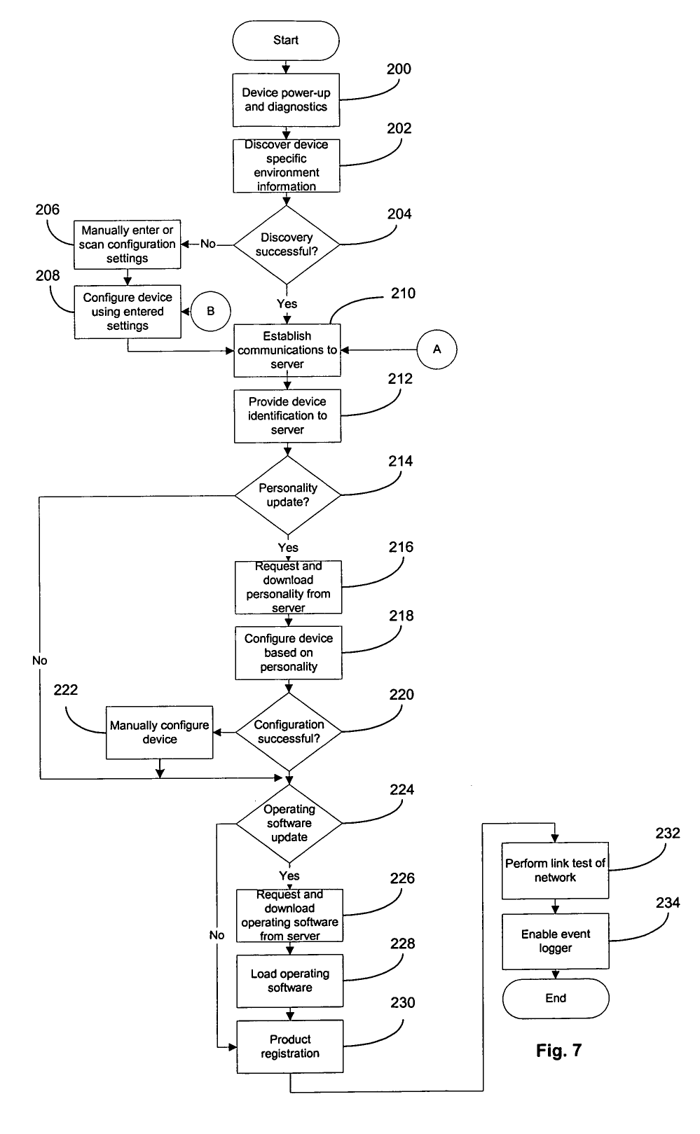

As will be appreciated, the above described functions, using the flow charts of FIG. 7-FIG. 9C and the accompanying description, easily can be programmed by a person having ordinary skill in the art of computer programming in any of a number of conventional programming languages based on the disclosure herein.

FIG. 7 illustrates the basic operation of the mobile terminal 36 in accordance with the procedures described above. Beginning at step 200 the processor 50 within the mobile terminal 36 initiates its own power-on self test (POST) upon being powered up and/or reset as is conventional. A diagnostic test is performed to check the integrity of various modules within the mobile terminal 36 and a report is generated to indicate base device health and the possible need for service. The report can be viewed by a user on the display 56 or stored in memory for retrieval at a later time. Memory includes, for example, the memory 60 of the mobile terminal 36 and/or memory 76 of the server 40, e.g., the database 130. Alternatively, the POST report can be compared to a “pre-shipment” POST report stored in memory 60 of the mobile terminal 36, and the differences between the reports can be stored in memory to provide a record for future support.

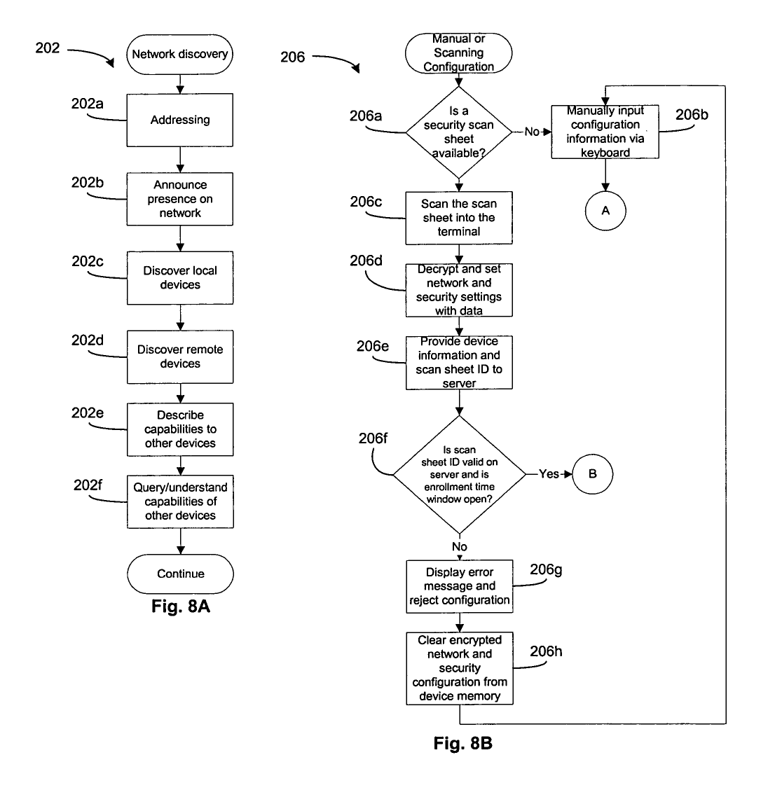

Next, in step 202 the processor 50 generates a discovery sequence, wherein specific information related to the network environment is sought. Referring briefly to FIG. 8A, the discovery process is illustrated in more detail. The processor automatically obtains an IP address at step 202a. To obtain an IP address, the processor 50 checks IP addresses from a preset range of IP addresses stored in memory 60, for example. When an unused address is found, the processor 50 sets the IP address of the mobile terminal to the corresponding free IP address. After an IP address is obtained, the processor 50 announces its presence on the network as shown at step 202b. The announcement includes any embedded devices and/or services included within the mobile terminal 36. Any interested device, e.g., another terminal 36, a wireless router 28, etc., can listen to the announcement for notifications that a new device and capabilities are available on the network. Following step 202b, the processor 50 initiates in step 202c and step 202d a search for both local and remote devices on the network. The search includes a search message sent by the processor 50, wherein the message includes a pattern or target, equal to a type of identifier for a device or service. Devices matching the pattern/target respond to the source IP address that sent the search request. At step 202e, the processor 50 describes its capabilities to other devices, including available services and/or embedded devices. The processor 50 at step 202f queries discovered devices to retrieve the capabilities of the other devices. The query includes a message requesting device specific information from a particular device. The processor 50 then stores the discovered information in memory 60.

Referring back to FIG. 7, the processor 50 at step 204 checks whether the discovery process was successful. Discovery may fail, for example, when the range of preset IP addresses scanned by the processor 50 are not available and/or not compatible with the system setup. Additionally, discovery may fail if automated discovery components are not available on the network.

If the discovery process is not successful, then at step 206 the terminal 36 displays a message on the display 56 indicating that a manual configuration is required. A user then configures the mobile terminal by scanning configuration settings into the mobile terminal 56 using the bar code reader 54 and/or the user input device 52.

For example, a personal computer (PC) or server based utility can be used to produce an encrypted set of bar codes. The encrypted bar codes would contain the required network and security information that can be scanned and understood by the processor 50. Bar codes should be delimited with field identification to prevent incorrect scans or a 2-D bar code could be used that contains all required network and security configuration data for configuring the mobile terminal.

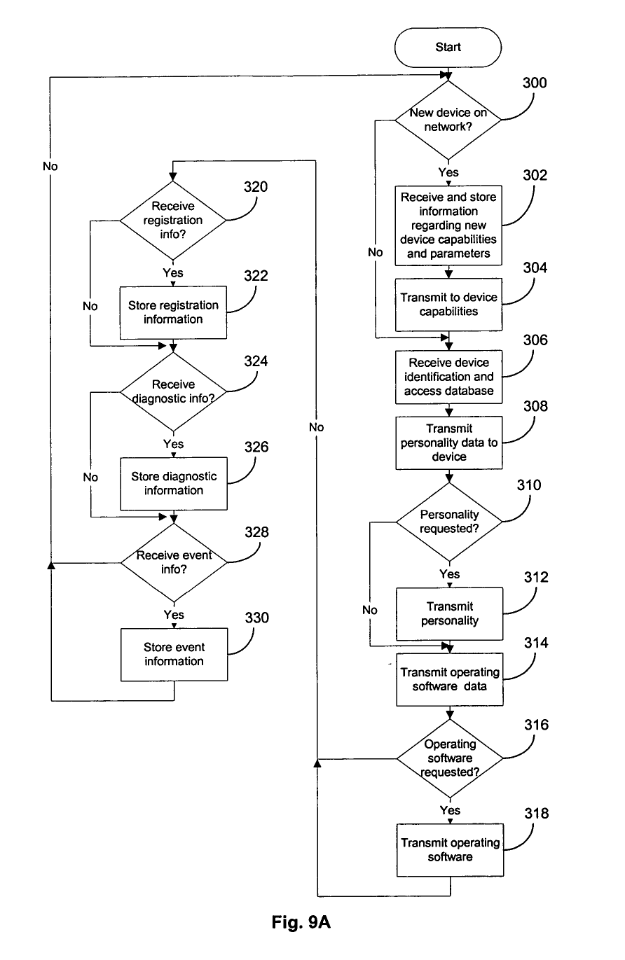

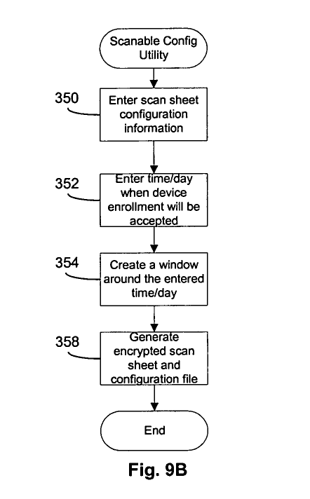

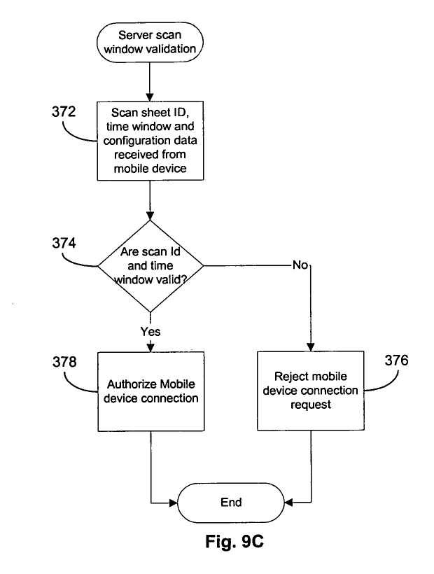

Referring briefly to FIG. 8B, details of a manual configuration process for the mobile terminal are illustrated. At step 206a, the user decides to use an encrypted scan sheet, if available, or to manually enter known network and security information. If a manual entry is selected, then the processor 50 moves to step 206b and the mobile terminal is manually configured via the user input device 52. If, on the other hand, a scan sheet is selected, then the processor 50 moves to step 206c and the scan sheet is scanned into the terminal using the bar code reader 54. The scan sheet includes a unique identifier that is assigned to the specific scan sheet created by a scan sheet utility (discussed below with respect to FIG. 9B), a time/date window, and configuration data. The server 40 contains a software component that validates scan sheet information and authorizes the mobile terminal connection to server 40, as described in more detail with respect to FIG. 9C. The use of the encrypted scan sheet and server 40 software mechanism limits the effective time window when a terminal can be authorized to connect to the server for a personality update. The connection information (e.g., identifier, time/date window) is encoded on the scan sheet. At step 206d the mobile terminal 36 decrypts or decodes the scanned encrypted data and configures the required network and security settings to enable a connection to the network and the scan sheet authorization software on the server 40. This scan sheet information is sent to the server in step 206e. The server 40 processes the received information at step 206f, to determine if the current time window is valid for the scanned security scan sheet information received from the mobile terminal. If the server 40 determines the enrollment window and scan sheet information are valid, it will approve connection to the server for personality downloads and the mobile terminal will continue to step 208 (FIG. 7) where the processor 50 configures the terminal based on the configuration data and stores the configuration in memory 60. If the server 40 determines the scan sheet to be invalid against the current enrollment window, the mobile terminal 36 will display an error message indicating the rejection of the configuration, as shown at step 206g. At step 206h, the processor 50 removes the encrypted network and security configuration from the mobile terminal memory 60. With the scanned configuration information now discarded, the mobile terminal's 36 processor will continue on to step 206b for manual configuration and then moves to step 210. Thus, even if the automatic configuration fails, the mobile terminal still can be securely configured without intervention of an IT professional.

In some instances, a “partial” manual configuration may be required before a fully automatic configuration can be performed. For example, before a wireless device can communicate on a wireless network, the wireless device (e.g., the mobile terminal 36) requires the Extended Service Set Identification (ESSID) and, if enabled, the encryption settings. The ESSID and encryption settings can be scanned in using the bar code reader 54 and/or typed in via the user input 52 as described above. The client 110 utilizes encrypted or encoded bar codes to provide a secure configuration of the mobile device for connection to secure networks. Once entered into the mobile terminal 36, the processor 50 uses the settings to configure the wireless parameters and thus can obtain access to the network 22. A subsequent reset of the mobile terminal 36 restarts the discovery process, allowing the processor to perform the discovery routine.

Mobile devices often require peripherals (e.g., serial/USB connected printers, magnetic strip readers, etc.) to perform solution tasks. These components also need to be configured with the correct version of software or the mobile device may need to update the software/driver to interact with a given peripheral. Discovery includes the peripherals that are associated with the mobile device.

Once the discovery process or a manual configuration is successful, the processor 50 at step 210 establishes communications with the server 40. At step 212, the processor 50 provides the server 40 with its identification code, such as the MAC address, for example.

Moving to step 214, the processor 50, using conventional techniques, determines whether a personality update is required. If a new personality is not required, then the processor 50 moves to step 224. If a personality update is required, then at step 216 the processor 50 requests and downloads the new personality from the server 40. At step 218, the processor proceeds to load the new personality into memory 60. Once the new personality is loaded, the mobile terminal 36 will take on the personality specified by the personality profile, e.g., it will change operating modes, enable/disable applications, limit access to certain information and/or individuals, etc.

Using conventional means, the processor 50 at step 220 determines whether the download and configuration of the personality was successful. If the processor determines that the download and/or configuration were not successful, then at step 222 the processor 50 displays a message on the display 56 that a manual configuration of the personality is required. Manual configuration can be accomplished using the user input 52 and/or using the bar code reader 54 to scan in a device personality, for example. Other alternatives for configuring the mobile terminal personality include an on-board configuration wizard, a web based configuration wizard, a PC based utility wizard and a cloning wizard, e.g., transfer the personality from one device to another through a peer-to-peer connection.

At step 224, the processor 50, using conventional techniques, determines whether an update of the operating software is required. If an update of the operating software is not required, then the processor 50 moves to step 230. If an update of the operating software is required then processor 50 requests and downloads the new operating software from the server 40. At step 226, the processor proceeds to load the new operating software into memory 60. Additional details regarding the determination of whether a software update is required/available and the automatic update of the software can be found in U.S. Pat. No. 5,848,064, the disclosure of which is incorporated by reference.

As will be appreciated, a terminal update sequence may be manually initiated by a user at any time. For example, through the user input device 52, a request can be made by a user to check the server 40 for personality updates (or operating software). Once initiated, the processor 50 performs the update procedures discussed above.

At step 230, the processor 50 automatically registers the mobile terminal 36 with the terminal manufacturer. Registration of the mobile terminal 36 ensures that the mobile terminal owner receives updates pertaining to software and/or software maintenance for the terminal 36. The processor registers the mobile terminal by sending the MAC address, the device model number, and owner information (if entered into the terminal) along with any other registration information to the server 40 via the network 22. The server 40 then records the information in the database 130 using the MAC address of the mobile terminal 36 as the storage criteria.

Moving to step 232, the processor 50 performs a link test of the network 22 and collects system data. Link tests are well known by those having ordinary skill in the art of computer networks and will not be discussed in detail herein. Briefly, a link test determines the state of the network link between the mobile terminal 36 and the server 40. During the test, the server 40 regularly transmits a link test pulse to the mobile terminal 36, and the time required for the test pulse to arrive at the mobile terminal and return to the server 40 is called the trip time. Link test trip times exceeding a specified value may indicate network problems. The link test trip time and related information are recorded by the server 40 along with other diagnostic information for use in performance analysis and fault isolation, for example.

At step 234 the processor 50 enables an event logger. Events are generated for various actions that occur with the mobile terminal and its environment. These events include, for example, battery status, cradle insertion/removal, peripheral discovery, security violation and diagnostic events. Generated events are sent to the server 40 for processing or routing to third party management tools by standard based network management protocols such as, for example, Simple Network Management Protocol (SNMP).

At the completion of step 234, the mobile terminal is configured and ready for end user operation. The processor 50 will be active and monitoring the server 40 for available updates or configuration changes as well as collection device operation information and generating events.

FIG. 9A illustrates the basic operation of the operation of the server 40. Beginning at step 300, the processor 74 monitors the network 22 for an announcement of a new device on the network. If an announcement is not received, the processor 74 moves to step 306. If an announcement is received, then the processor 74 at step 302 receives and stores the announced information, e.g., the device capabilities, parameters, etc. The information is stored in the database 130 using the MAC address of the device as the storage criteria, for example. At step 304, the processor 74, in response to a query by the mobile terminal 36, transmits to the mobile terminal the services and capabilities of the server 40. This can include, for example, the file distribution service 122, the data collection service 124, the configuration service 126, etc.

Moving to step 306, the processor 74 receives the identification code, e.g., the MAC address, from the mobile terminal 36, and the processor 74 uses the identification code to retrieve information pertaining to the specific identification code from the database 130. The processor 74, using the information obtained from the database 130, transmits the latest personality data to the mobile terminal 36. At step 310, the processor 74 determines whether the mobile terminal 36 has requested an update of the personality. As discussed previously, the mobile terminal 36 determines whether a personality update is required.

If a request is not received, the processor 74 moves to step 314. If, on the other hand, a request has been received, the processor 74 proceeds to transmit the personality file(s) to the mobile terminal 36. The actual transmission of the personality file(s) to the mobile terminal 36 is handled by the file distribution service 122, as is conventional. Additionally, information made available by the configuration service, which is stored in the database, is used to update the device personality.

At step 314, the processor 74 transmits the latest operating software data to the mobile terminal. The processor then determines at step 316 whether the mobile terminal 36 has requested an operating software update. As with the personality, the mobile terminal 36 determines whether an operating software update is required. If the mobile terminal has not requested an operating software update, then the processor 74 moves to step 320. If the mobile terminal has requested an operating software update, then at step the processor 74 proceeds to transmit the operating software to the mobile terminal. Again, the actual transmission of the file(s) to the mobile terminal 36 is handled by the file distribution service 122, as is conventional.

Moving to step 320, the processor 74, using conventional techniques, determines whether registration information has been received from the mobile terminal 36. If registration information has not been received, then the processor 74 moves to step 324. If registration information has been received, then the processor 74 at step 322 proceeds to store the information, for example, in the database 130 using the identification code of the mobile terminal 36 as the storage criteria.

At step 324, the processor 74 determines whether diagnostic information has been received from the mobile terminal 36. If diagnostic information has not been received, then the processor 74 moves to step 328. If diagnostic information has been received, then the processor 74 at step 326 proceeds to store the diagnostic information in the database 130 using the identification code of the mobile terminal 36 as the storage criteria.

At step 328, the processor 74 determines whether event information has been received from the mobile terminal 36. If event information has not been received, then the processor 74 moves back to step 300 and the process repeats. If event information has been received, then the processor 74 at step 330 proceeds to transmit the event data to for processing or routing to third party management tools in SNMP. Once the event information is stored, the processor moves back to step 300 and the process repeats.

FIG. 9B illustrates the operation of a utility for creating a secure scan sheet, which can be used for manual configuration of a mobile terminal 36. The utility may be run on a PC or on a server, for example. As described above, a mobile terminal 36 may be manually configured using encrypted scan sheets that include configuration information. The utility, based on user specified data, creates the encrypted scan sheets and a server configuration file. The data inputted into the utility by the user includes a time/date value, a time window around the specified time/date in which the operation will be valid, and configuration data including encrypted network and security configuration information.

Beginning at step 350, the scan sheet configuration information (e.g., network settings, operation modes, etc.) for the mobile terminal are entered into the utility, for example, by typing the information into a PC or server through a keyboard or a touch screen. Next at step 352, the approximate time and date the scanning configuration will be allowed is entered into the utility. The time and date is used by the utility in step 354 to create a “window” in which the data on the scan sheet is valid. The size of the window is determined by the user and can range in time depending on the user's preferences. At step 358, the utility generates an encrypted scan sheet containing a unique scan sheet identifier code along with the other entered information. The utility uses a random number generator to create the scan sheet identifier. The utility also saves the scan sheet information including the unique identifier and user data in a server configuration file. As described above with regards to FIG. 8B, the scannable sheet is used by the mobile device to input configuration information to establish a connection to the server 40 and to send this information to obtain authorization. The server configuration file is used by the server 40 to determine if the current time window is valid for the scanned security scan sheet information received from the mobile terminal. If the server 40 determines the enrollment window and scan sheet information is valid, it will approve configuration of the mobile terminal, and the mobile device is will apply the configuration as described at step 208 (FIG. 7). If the server 40 determines the scan sheet to be invalid against the current enrollment window, the mobile device will discard all scanned configuration information.

FIG. 9C illustrates the operation of a utility performed by the server 40 for validating the scan sheet data loaded into the mobile terminal 36. Beginning at step 372, the scan sheet ID, time window and configuration data are transmitted by the mobile terminal 36 to the server 40. At step 374, the server checks whether the received data is valid by comparing the data to the stored configuration file generated in FIG. 9B. If the data is not valid, e.g., the data does not match the configuration file and/or the time/date window has expired, the mobile terminal connection request is rejected, and the mobile terminal discards the scan sheet configuration (see FIG. 8B). If, however, the data is valid, e.g., the data matches the configuration file and the request is within the time/date window, then at step 378 the server authorizes the mobile terminal connection, which permits the mobile terminal to configure itself according to the scan sheet data (see FIG. 8B) and obtain network access for software updates.

Although the invention has been shown and described with respect to certain preferred embodiments, it is obvious that equivalents and modifications will occur to others skilled in the art upon the reading and understanding of the specification. For example, the present invention has been described with respect to the mobile terminal 36 determining whether a personality update is required. However, it will be appreciated that the server 40 can make the determination of whether an update to the mobile terminal's personality is required. The same concept can be applied to the operating software updates.

Furthermore, the file transfer protocol utilized in the present invention for transferring files between the mobile terminal and the host computer is not limited to any particular file transfer protocol. Any of a variety of known protocols such as HTTP, FTP and TFTP can be used without departing from the scope of the invention.

The present invention includes all such equivalents and modifications, and is limited only by the scope of the following claims.

1. A method of transacting business in conjunction with a sale of mobile devices, the method comprising the steps of:
shipping at least a first mobile device to a first end user and at least a second mobile device to a second end user different from the first end user, the first mobile device and the second mobile device having generally a same hardware and software configuration during shipping;
maintaining on at least one server coupled to a network configuration data for a plurality of mobile devices;
upon receipt of the first mobile device and the second mobile device by the first end user and the second end user, respectively, powering up the first mobile device and the second mobile device; and
upon being powered up, the first mobile device and the second mobile device each automatically connecting to the at least one server via the network;
downloading first configuration data and second configuration data, respectively, from the at least one server, the first configuration data and the second configuration data being generally different; and automatically configuring themselves based on the first configuration data and the second configuration data.

2. The method of claim 1, wherein the step of maintaining configuration data for a plurality of mobile devices includes the steps of:
storing in memory on the server an identification code for uniquely identifying each mobile device; wherein the configuration data corresponds to the identification code.

3. The method of claim 2, wherein the step of automatically connecting to the at least one server includes the steps of:
transmitting to the server an identification code of the respective mobile device; and
retrieving by the server configuration data based on the transmitted identification code.

4. The method of claim 1, further comprising a gateway for establishing remote communications between each mobile device and the server.

5. The method of claim 4, wherein the gateway is an internet connection.

6. The method of claim 4, wherein the gateway is an intranet connection.

7. The method of claim 1, further comprising the steps of:
configuring the mobile device manually in the event of a failure of the automatic configuration.

8. The method of claim 7, wherein the step of configuring the mobile device manually further comprises the steps of:
creating encrypted data, wherein the encrypted data includes an identifier, a time/date window, and configuration data;
entering the encrypted data into the mobile device;
verifying that the identification code and the time/date window relative to the particular mobile device; and
using the configuration data to configure the mobile device, wherein the configuration is conditioned upon the verification of the identifier and the time/date window.

9. A method for maintaining configuration data on a server coupled to a network, the method comprising the steps of:
storing in memory on the server different configuration data for a plurality of different mobile devices;
the server receiving, via the network, requests for the different configuration data from the different mobile devices, respectively; and
the server providing, via the network, the different configuration data to the different mobile devices, respectively.

10. The method of claim 9, wherein the step of storing in memory on the server different configuration data for a plurality of mobile devices includes storing in memory an identification code for uniquely identifying each mobile device, and each configuration data corresponds to a respective identification code.

11. The method of claim 9, further comprising a gateway for establishing remote communications between each mobile device and the server.

12. The method of claim 11, wherein the gateway is an internet connection.

13. The method of claim 11, wherein the gateway is an intranet connection.

14. A self configuring mobile device, comprising:
a discovery module for discovering device specific information on a wireless computer network;
a communication module for transmitting data to and receiving data from the wireless computer network, wherein the communications module obtains device specific information from the discovery module to establish a communications link to at least one device;
an update module operatively coupled to the communications module for querying the at least one device to obtain a configuration update; and
a configuration module for configuring the mobile device, wherein the configuration module implements the configuration update to configure the mobile device to a custom configuration.

15. The self configuring mobile device of claim 14, further comprising a user input module for entering data corresponding to the configuration of the mobile device.

16. The self configuring mobile device of claim 15, wherein the user input module is a keypad.

17. The self configuring mobile device of claim 15, wherein the user input module is a bar code reader.

18. The self configuring mobile device of claim 14, wherein the self configuring mobile device initially is configured in a generic state.

19. A wireless communication system, comprising:
at least one system backbone;
at least one host computer coupled to the system backbone;
a wireless remote station coupled to the at least one system backbone; and
the self configuring mobile device of claim 14, wherein the self configuring mobile device and the at least one host computer are operatively configured to wirelessly communicate configuration information therebetween, and the self configuring mobile device changes a first configuration setting to a second configuration based on a plurality of configuration data received from the at least one host computer, said second configuration setting being specific to a particular environment.

20. The system of claim 19, further comprising:
a local station coupled to the at least one system backbone and to at least one remote communication link, wherein the wireless remote station is coupled to the at least one system backbone through the remote communication link and the local station.

21. The system of claim 20, wherein the at least one remote link is an internet connection.

22. The system of claim 20, wherein the at least one remote link is an intranet connection.

23. The system of claim 20, wherein the local station and the wireless remote station are routers.

24. The system of claim 19, wherein the environment is a computer network.

25. The system of claim 19, wherein the environment is a computer management system for managing business operations.

26. The system of claim 19, wherein the at least one host computer includes a memory and a database stored in the memory.

27. The system of claim 26, wherein the database comprises:
an identification entry for uniquely identifying each self configuring mobile device in the system; and
a configuration entry for specifying the configuration of the self configuring mobile device, wherein the configuration entry corresponds to the identification entry.

28. The system of claim 27, wherein the identification entry is selected from the group consisting of a Media Access Control (MAC) address, a device serial number, and a Central Processing Unit (CPU) identification code.

29. The system of claim 27, wherein the database further comprises at least one of an operating software entry, a diagnostic data entry, a registration data entry and a device capabilities entry.
